(19) United States
(12) Patent Application Publication
(10) Pub. No.: US 2020/0211094 A1
(43) Pub. Date: Jul. 2, 2020

(54) CALLING METHOD AND SYSTEM, AND ELECTRONIC PRICE TAG DEVICE

(71) Applicant: BOE TECHNOLOGY GROUP CO., LTD., Beijing (CN)

(72) Inventors: Hongtao GUAN, Beijing (CN); Tao LI, Beijing (CN); Kejun HU, Beijing (CN)

(21) Appl. No.: 16/621,106

(22) PCT Filed: Apr. 3, 2019
(86) PCT No.: PCT/CN2019/081291

§ 371 Date: Dec. 10, 2019

(30) Foreign Application Priority Data
May 22, 2018 (CN) 201810494294.6

(51) Int. Cl. G06Q 30/06; G06Q 30/02; G06F 16/23; H04W 4/021

(52) U.S. Cl. CPC G06Q 30/0639; H04W 4/021; G06F 16/23; G06Q 30/0281

(57) ABSTRACT

The disclosure provides a calling method and system and an electronic price tag device. The calling method includes steps of: the electronic price tag device generating request information according to an operation instruction of a user and sending the request information including first position information of the electronic price tag device to a server; the server determining a shopping guide terminal corresponding to the first position information according to the first position information; and the server sending calling information including the first position information to the shopping guide terminal corresponding to the first position information.

### CROSS-REFERENCE TO RELATED APPLICATION

This is a National Phase application filed under 35 U.S.C. 371 as a national stage of PCT/CN2019/081291, filed on Apr. 3, 2019, an application claiming the benefit of priority to Chinese Patent Application No. 201810494294.6 filed on May 22, 2018, the contents of which are incorporated herein in their entirety by reference.

### TECHNICAL FIELD

The present disclosure relates to the field of communication, and in particular, to a calling method and system, and an electronic price tag device.

### BACKGROUND

The existing commodity price tag is only used for showing commodity price tag information such as commodity price, commodity origin, commodity name and the like. When a user purchases a commodity, the user sometimes cannot know all information of the commodity according to the commodity price tag information, and needs to consult a shopping guide of a supermarket to obtain further information of the commodity. However, in a large supermarket, the user sometimes cannot find the shopping guide in time, which degrades the shopping experience of the user.

### SUMMARY

According to an aspect of the disclosure, there is provided a calling method including steps of: an electronic price tag device generating request information according to an operation instruction of a user and sending the request information to a server, wherein the request information includes first position information of the electronic price tag device; the server determining a shopping guide terminal corresponding to the first position information; and the server sending calling information to the shopping guide terminal corresponding to the first position information, wherein the calling information includes the first position information.

According to an embodiment of the disclosure, before the step of the server determining a shopping guide terminal corresponding to the first position information, the method further includes steps of: the server receiving signal strength indication information and state information sent from a plurality of shopping guide terminals; and the server generating second position information of each of the plurality of shopping guide terminals according to the signal strength indication information; and the step of the server determining the shopping guide terminal corresponding to the first position information includes: the server determining a shopping guide terminal corresponding to the first position information from the plurality of shopping guide terminals according to the first position information of the electronic price tag device and the second position information and the state information of each shopping guide terminal.

According to an embodiment of the disclosure, the calling method further includes a step of: the electronic price tag device receiving an update instruction sent from the server and updates price tag information stored in the electronic price tag device according to the update instruction, wherein the update instruction includes price tag information for updating, and the price tag information for updating includes the first position information of the electronic price tag device.

According to an embodiment of the disclosure, after the step of the server sending the calling information to the shopping guide terminal corresponding to the first position information, the calling method further includes a step of: the shopping guide terminal that receives the calling information sending out a prompt signal and displaying the first position information corresponding to the electronic price tag device, according to the calling information.

According to an embodiment of the disclosure, the calling method further includes steps of: the electronic price tag device determining whether the operation instruction of the user is received or not; if the operation instruction of the user is received, the electronic price tag device performing the step of generating the request information according to the operation instruction of the user, and if the operation instruction of the user is not received, the electronic price tag device continuing determining whether the operation instruction of the user is received or not.

According to another aspect of the disclosure, there is provided an electronic price tag device including a housing, a first processor and a first transceiver within the housing, and a call button on an outer surface of the housing. The call button is configured to generate an operation instruction when pressed by a user and to send the operation instruction to the first processor, the first processor is configured to generate, according to the operation instruction of the user, request information including first position information of the electronic price tag device, and the first transceiver is configured to send the request information to a server.

According to an embodiment of the disclosure, the first transceiver is further configured to receive an update instruction sent from the server, the update instruction includes price tag information for updating, and the price tag information for updating includes the first position information of the electronic price tag device; and the first processor is further configured to update price tag information stored in the electronic price tag device according to the update instruction.

According to another aspect of the disclosure, there is provided a calling system including a server, a plurality of shopping guide terminals and the electronic price tag device according to the disclosure. The electronic price tag device is configured to generate request information according to an operation instruction of a user and send the request information to the server, and the request information includes first position information of the electronic price tag device; and the server is configured to determine a shopping guide terminal corresponding to the first position information and send calling information to the shopping guide terminal corresponding to the first position information, and the calling information includes the first position information.

According to an embodiment of the disclosure, each of the plurality of shopping guide terminals is configured to send signal strength indication information and state information to the server, and the server is further configured to receive the signal strength indication information and the state information sent from the plurality of shopping guide terminals, generate second position information of each of the plurality of shopping guide terminals according to the signal strength indication information, and determine, according to the first position information of the electronic price tag device and the second position information and the state information of each shopping guide terminal, the shopping guide terminal corresponding to the first position information from the plurality of shopping guide terminals.

According to an embodiment of the disclosure, each of the plurality of shopping guide terminals includes a second transceiver, a second processor and a prompter. The second transceiver is configured to receive the calling information, the second processor is configured to send a prompt signal to the prompter after the second transceiver receives the calling information, and the prompter is configured to provide a prompt according to the prompt signal.

According to an embodiment of the disclosure, each of the plurality of shopping guide terminals further includes a display screen. The second processor is further configured to, after the second transceiver receives the calling information, generate a display signal including the first position information, and send the display signal to the display screen, and the display screen displays the display signal.

According to an embodiment of the disclosure, the first transceiver of the electronic price tag device is further configured to receive an update instruction sent from the server, the update instruction includes price tag information for updating, and the price tag information for updating includes the first position information of the electronic price tag device; and the first processor of the electronic price tag device is further configured to update price tag information stored in the electronic price tag device according to the update instruction.

According to an embodiment of the disclosure, the calling system includes a plurality of electronic price tag devices described above.

### BRIEF DESCRIPTION OF THE DRAWINGS

FIG. 1 is a flow chart of a calling method according to an embodiment of the present disclosure;

FIG. 2 is a flow chart illustrating a calling method according to another embodiment of the present disclosure;

FIG. 3A is a schematic diagram of an external configuration of an electronic price tag device according to an embodiment of the present disclosure;

FIG. 3B is a block diagram of an electronic price tag device according to an embodiment of the present disclosure;

FIG. 4 is a schematic structural diagram of a calling system according to an embodiment of the present disclosure; and

FIG. 5 is a block diagram of a shopping guide terminal shown in FIG. 4.

### DETAILED DESCRIPTION

To enable those skilled in the art to better understand the technical solutions of the present disclosure, the technical solutions of the present disclosure will be clearly and completely described below with reference to the accompanying drawings. It is to be understood that the embodiments described herein are part, but not all, of the embodiments of the present disclosure. All other embodiments, which can be derived by a person of ordinary skill in the art without making any creative effort based on the embodiments in the present disclosure, fall within the protection scope of the present disclosure.

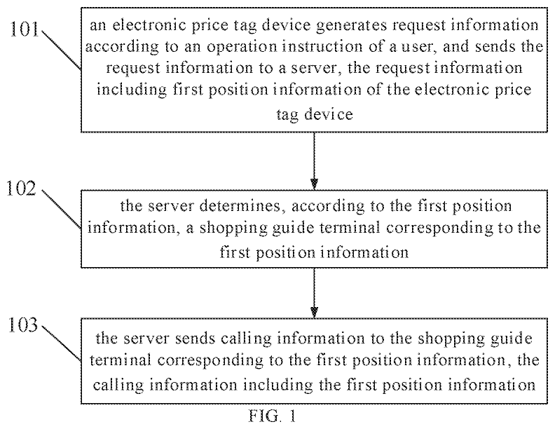

FIG. 1 is a flow chart of a calling method according to an embodiment of the present disclosure.

As shown in FIG. 1, the calling method according to the present embodiment includes steps 101 to 103.

In step 101, an electronic price tag device generates request information according to an operation instruction of a user, and sends the request information to a server. The request information includes first position information of the electronic price tag device.

In step 102, the server determines, according to the first position information, a shopping guide terminal corresponding to the first position information.

In step 103, the server sends calling information to the shopping guide terminal corresponding to the first position information. The calling information includes the first position information.

According to the calling method of the embodiment, the electronic price tag device generates the request information according to the operation instruction of the user, and sends the request information to the server, and the request information includes the first position information of the electronic price tag device. The server determines the shopping guide terminal corresponding to the first position information according to the first position information. The server sends the calling information to the shopping guide terminal corresponding to the first position information, and the calling information includes the first position information. The calling method can effectively improve the shopping experience of the user, and hence increase the customer traffic and the sales volume and improve the shopping guide efficiency.

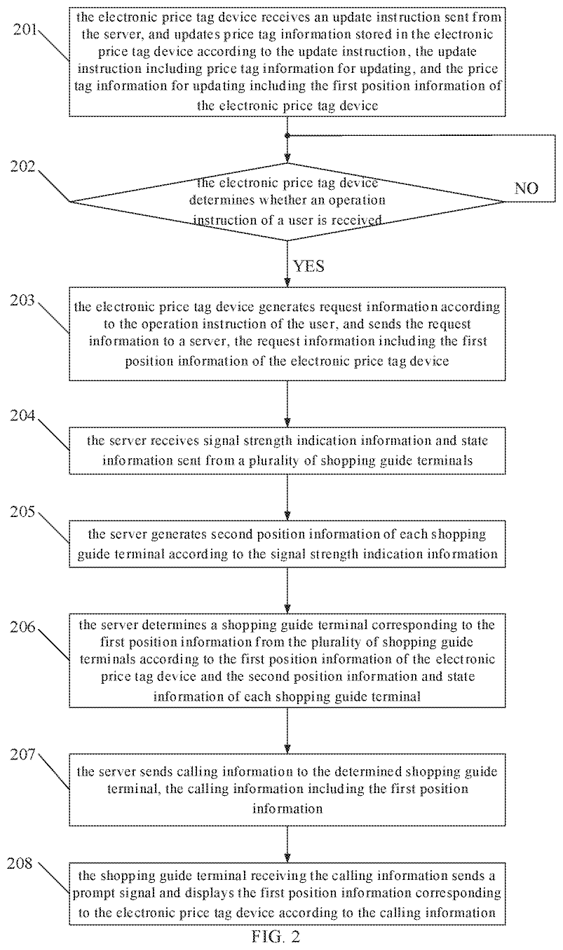

FIG. 2 is a flow chart illustrating a calling method according to another embodiment of the present disclosure.

As shown in FIG. 2, the calling method according to the present embodiment includes steps 201 to 208.

In step 201, the electronic price tag device receives an update instruction sent from the server, and updates the price tag information stored in the electronic price tag device according to the update instruction. The update instruction includes price tag information for updating, and the price tag information for updating includes the first position information of the electronic price tag device.

The electronic price tag device is generally used for displaying the price tag information of a commodity to a user, so that the user can purchase the commodity according to the price tag information.

The update instruction may include the price tag information for updating, and the price tag information for updating may include commodity name, commodity price, commodity origin, and the first position information of the electronic price tag device. The first position information indicates a position where the electronic price tag device is located, and for example, the first position information is a shelf number of a shelf where a commodity corresponding to the electronic price tag device is located.

After receiving the update instruction sent from the server, the electronic price tag device may replace original price tag information according to the price tag information for updating carried in the update instruction, and therefore the purpose of updating the price tag information is achieved.

When the electronic price tag device is initialized, the server sends an update instruction to the electronic price tag device to initialize the electronic price tag device. In this case, the update instruction includes price tag information, which is price tag information of a corresponding commodity in the initialization process, so as to realize the initialization update of the price tag information.

When the price tag information of the commodity changes, the server sends an update instruction to the electronic price tag device so that the electronic price tag device can update the price tag information. In this case, the update instruction includes price tag information for updating, which is price tag information of a corresponding commodity to be updated in the update process. The electronic price tag device can replace original price tag information with the price tag information for updating included in the update instruction, so that the price tag information is updated.

In step 202, the electronic price tag device determines whether an operation instruction of a user is received, and if the operation instruction of the user is received, step 203 is performed; otherwise, step 202 is repeated.

The electronic price tag device is in a standby state after completing the update of the price tag information, and at this time, the electronic price tag device determines in real time whether or not an operation instruction of the user is received (step 202). The operation instruction of the user may be an operation instruction generated by, for example, pressing a call button on the electronic price tag device.

In step 203, the electronic price tag device generates request information according to the operation instruction of the user, and sends the request information to the server. The request information includes the first position information of the electronic price tag device.

The electronic price tag device determines that the user sends a request for shopping guide according to the operation instruction of the user, and generates request information according to the operation instruction of the user. According to the embodiment of the present disclosure, the electronic price tag device may send the request information to a wireless access point (AP) to which the electronic price tag device belongs, and the AP may further send the request information to the server. In the embodiment, the number of APs is plural, and each AP may be connected to at least one electronic price tag device and/or at least one shopping guide terminal. Both the electronic price tag device(s) and the shopping guide terminal(s) may communicate with the server through the AP(s) connected to the electronic price tag device(s) and the shopping guide terminal(s).

In step 204, the server receives signal strength indication information and state information sent from a plurality of shopping guide terminals.

The signal strength indication information may be a received signal strength indication (RSSI) value. The shopping guide terminal sends the RSSI value to the server in real time through the AP connected to the shopping guide terminal, and the server receives the RSSI values sent in real time from the plurality of shopping guide terminals.

According to the embodiment of the present disclosure, the state information includes two types of state information, i.e., busy state information and idle state information. The busy state information indicates that a shopping guide carrying the shopping guide terminal cannot provide the client with shopping guide service at the moment, and the idle state information indicates that a shopping guide carrying the shopping guide terminal can provide the client with shopping guide service at the moment. When the state information of the shopping guide terminal changes, the shopping guide terminal sends the state information to the server in real time, and the server receives and stores the state information sent in real time from the plurality of shopping guide terminals.

The order of steps 202 and 204 may be altered as desired, e.g., step 204 may be performed before step 202, or step 202 and step 204 may be performed simultaneously.

In step 205, the server generates second position information of each shopping guide terminal according to the signal strength indication information.

The RSSI value sent by the shopping guide terminal has a corresponding relationship with a distance between the shopping guide terminal and the AP connected to the shopping guide terminal. The server firstly obtains the distance between the shopping guide terminal and a corresponding AP according to the RSSI value, and then generates the second position information of the shopping guide terminal according to a pre-stored map and the distance.

The server may update the second position information of the shopping guide terminal in real time according to the RSSI value of the shopping guide terminal. The second position information indicates a position of the shopping guide terminal, i.e., a position of a shopping guide carrying the shopping guide terminal.

In step 206, the server determines a shopping guide terminal corresponding to the first position information from the plurality of shopping guide terminals according to the first position information of the electronic price tag device and the second position information and state information of each shopping guide terminal.

The server selects the shopping guide terminal which is closest to the electronic price tag device and is in an idle state according to the first position information of the electronic price tag device, and the second position information of each shopping guide terminal and the state information.

In step 207, the server sends calling information to the determined shopping guide terminal. The calling information includes the first position information.

The server sends the calling information to the AP connected to the determined shopping guide terminal, and the AP further sends the calling information to the shopping guide terminal.

In step 208, the shopping guide terminal receiving the calling information sends a prompt signal and displays the first position information corresponding to the electronic price tag device according to the calling information.

After receiving the prompt signal, the shopping guide carrying the shopping guide terminal can reach the position of the electronic price tag device corresponding to the first position information according to the first position information displayed by the shopping guide terminal, and provide the customer who sends the request with shopping guide service for the commodity corresponding to the electronic price tag device. According to the embodiment of the disclosure, the shopping guide carrying the shopping guide terminal may update the state information of the shopping guide terminal from idle state information to busy state information after receiving the prompt signal, and the updated state information may be sent to the server in real time.

According to the embodiment of the disclosure, after receiving the prompt signal, the shopping guide carrying the shopping guide terminal may send a confirmation feedback signal to the server to indicate that the shopping guide confirms to provide shopping guide service.

Alternatively, after receiving the prompt signal, the shopping guide carrying the shopping guide terminal may send a rejection feedback signal to the server to indicate that the shopping guide is currently not available for shopping guide service, and the method returns back to step 206.

According to the embodiment of the disclosure, a terminal identifier of at least one shopping guide terminal with the highest priority is prestored in the electronic price tag device. Step 203 in the calling method according to the present embodiment may include: the electronic price tag device generating request information according to the operation instruction of the user, and sending the request information to the server, and the request information includes the first position information of the electronic price tag device and the terminal identifier of the shopping guide terminal with the highest priority stored in the electronic price tag device. Step 206 in the calling method according to the present embodiment may further include: the server determining the shopping guide terminal corresponding to the first position information from the plurality of shopping guide terminals according to the first position information of the electronic price tag device, the terminal identifier of the shopping guide terminal with the highest priority, and the second position information and the state information of each shopping guide terminal. In an embodiment, the server selects the shopping guide terminal which is closest to the electronic price tag device, has the state information of idle state information and has the highest priority, according to the first position information of the electronic price tag device, the second position information and the state information of each shopping guide terminal and the terminal identifier of the shopping guide terminal with the highest priority.

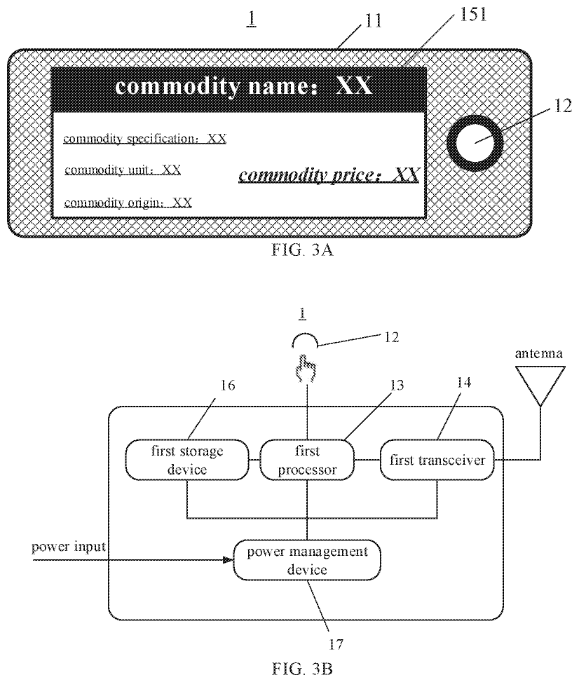

FIG. 3A is a schematic diagram of an external configuration of an electronic price tag device according to an embodiment of the present disclosure, and FIG. 3B is a block diagram of an electronic price tag device according to an embodiment of the present disclosure.

As shown in FIGS. 3A and 3B, the electronic price tag device 1 according to the embodiment of the present disclosure includes a housing 11 and a first processor 13 and a first transceiver 14 provided inside the housing 11, and a call button 12 is provided on an outer surface of the housing 11. An operation instruction may be generated and sent to the first processor 13 when the user presses the call button 12. The first processor 13 generates request information including first position information of the electronic price tag device 1 according to the operation instruction of the user. The first transceiver 14 sends the request information to the server. After receiving the request information, the server may determine the shopping guide terminal corresponding to the first position information according to the first position information, and send calling information to the determined shopping guide terminal. The calling information includes the first position information.

According to an embodiment of the present disclosure, a first display screen 151 may be provided on the housing 11, and the call button 12 may be provided at one side of the first display screen 151. The first display screen 151 may display price tag information (i.e., commodity information corresponding to the electronic price tag device). The price tag information may include, for example, one or any combination of commodity name, commodity price, commodity origin, commodity specification, and commodity unit. Although not shown in the drawings, a call button label may be provided beside the call button 12 for the user to understand the function of the call button 12. The call button label may be, for example, a call to a shopping guide. The first processor 13 may send display information to the first display screen 151, and the display information may include the price tag information so that the first display screen 151 may display the price tag information.

According to an embodiment of the present disclosure, the first transceiver 14 may also receive an update instruction sent from the server. The update instruction may include price tag information for updating. The first processor 13 may also update the price tag information, which may include the first position information of the electronic price tag device, according to the update instruction. The first processor 13 may include, but is not limited to, a central processing unit (CPU).

The first transceiver 14 may include a wireless communication component, such as a bluetooth component, a WIFI component, or a 4G network component, which may communicate wirelessly through an antenna.

According to the embodiment of the present disclosure, the first processor 13 may determine whether an operation instruction of the user is received, and if the operation instruction of the user is received, generate the request information according to the operation instruction of the user; if the operation instruction of the user is not received, continues determining whether the operation instruction of the user is received.

The electronic price tag device 1 may further include a first storage device 16 provided inside the housing 11. The first storage device 16 is coupled to the first processor 13. The first storage device 16 may store the price tag information. The first processor 13 may retrieve the stored price tag information from the first storage device 16.

The electronic price tag device 1 may further include a power management device 17 provided inside the housing 11 and coupled to a DC regulated power supply. The DC regulated power supply may supply power to each component of the electronic price tag device 1 through the power management device 17. For example, the DC regulated power supply may supply power to the first processor 13, the first transceiver 14, and the first storage device 16 through the power management device 17.

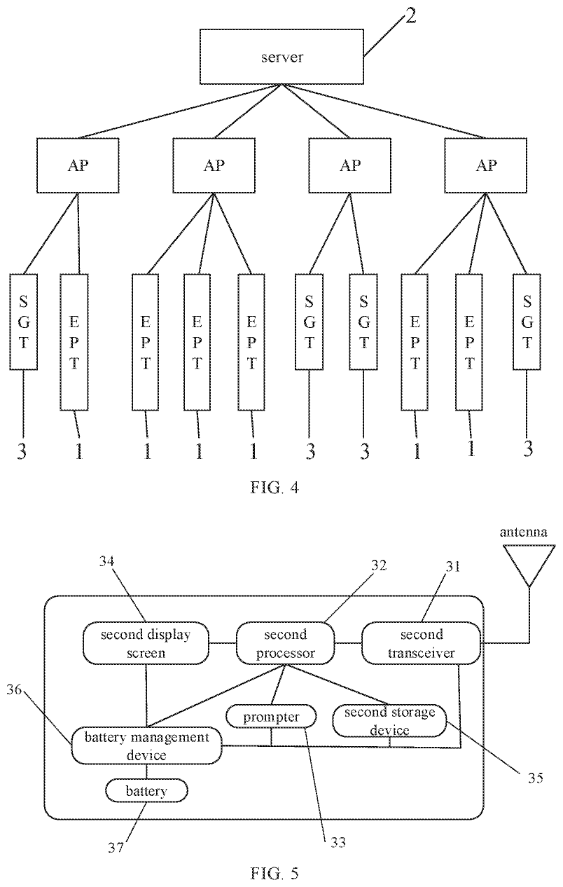

FIG. 4 is a schematic diagram of a calling system according to an embodiment of the present disclosure.

As shown in FIG. 4, the calling system according to the embodiment of the present disclosure includes: an electronic price tag device (EPT) 1, a server 2 and a shopping guide terminal (SGT) 3.

The electronic price tag device 1 generates request information including first position information of the electronic price tag device 1 according to an operation instruction of a user, and sends the request information to the server 2. The server 2 determines the shopping guide terminal 3 corresponding to the first position information according to the first position information, and sends calling information to the shopping guide terminal 3. The calling information includes the first position information. The shopping guide terminal 3 receives the calling information.

In addition, the shopping guide terminal 3 may also send signal strength indication information and state information to the server 2. The server 2 receives signal strength indication information and state information sent from a plurality of shopping guide terminals 3, generates second position information of each shopping guide terminal according to the signal strength indication information, and determines the shopping guide terminal 3 corresponding to the first position information from the plurality of shopping guide terminals 3 according to the first position information of the electronic price tag device 1 and the second position information and the state information of each shopping guide terminal 3.

According to the embodiment of the present disclosure, the calling system further includes a plurality of APs, each of which may be correspondingly connected to at least one electronic price tag device 1 and/or at least one shopping guide terminal 3. The electronic price tag device 1 and the shopping guide terminal 3 may communicate with the server 2 through a corresponding AP.

FIG. 5 is a block diagram of the shopping guide terminal shown in FIG. 4.

As shown in FIG. 5, the shopping guide terminal 3 may include a second transceiver 31, a second processor 32, and a prompter 33.

The second transceiver 31 may receive calling information. After the second transceiver 31 receives the calling information, the second processor 32 may send a prompt signal to the prompter 33. The prompter 33 may provide a prompt according to the prompt signal. The second processor 32 may include, but is not limited to, a CPU.

The prompter 33 may include one or any combination of a prompting light, a display screen, a sound generating device, and a vibration device.

The second transceiver 31 may include a wireless communication component that can wirelessly communicate through an antenna, for example, a bluetooth component, a WIFI component, or a 4G network component

According to an embodiment of the present disclosure, the shopping guide terminal 3 may further include a second display screen 34 coupled to the second processor 32.

After the second transceiver 31 receives the calling information, the second processor 32 may generate a display signal, which may include the first position information included in the calling information, and send the display signal to the second display screen 34. The second display screen 34 may display the first position information.

According to an embodiment of the present disclosure, the shopping guide terminal 3 may further include a second storage device 35. The second storage device 35 is coupled to the second processor 32 and configured to store the first position information.

According to an embodiment of the present disclosure, the shopping guide terminal 3 may further include a battery management device 36 and a battery 37. The battery management device 36 is coupled to the battery 37, which supplies power to various components in the shopping guide terminal 3 through the battery management device 36. For example, the battery 37 supplies power to the second display screen 34, the second processor 32, the prompter 33, the second transceiver 31 and the second storage device 35 through the battery management device 36.

The shopping guide terminal 3 may be a mobile terminal, such as a cell phone terminal.

It could be understood that the above embodiments are merely exemplary embodiments adopted for describing the principle of the present disclosure, but the present disclosure is not limited thereto. Various variations and improvements may be made by those of ordinary skill in the art without departing from the spirit and essence of the present disclosure, and these variations and improvements shall also be regarded as falling into the protection scope of the present disclosure.

1. A calling method, comprising steps of:
an electronic price tag device generating request information according to an operation instruction of a user and sending the request information to a server, wherein the request information comprises first position information of the electronic price tag device;
the server determining a shopping guide terminal corresponding to the first position information; and
the server sending calling information to the shopping guide terminal corresponding to the first position information, wherein the calling information comprises the first position information.

2. The calling method of claim 1, wherein before the step of the server determining a shopping guide terminal corresponding to the first position information, the calling method further comprises steps of:
the server receiving signal strength indication information and state information sent from a plurality of shopping guide terminals; and
the server generating second position information of each of the plurality of shopping guide terminals according to the signal strength indication information; and
the step of the server determining the shopping guide terminal corresponding to the first position information comprises:
the server determining a shopping guide terminal corresponding to the first position information from the plurality of shopping guide terminals according to the first position information of the electronic price tag device and the second position information and the state information of each shopping guide terminal.

3. The calling method of claim 1, further comprising a step of:
the electronic price tag device receiving an update instruction sent from the server and updates price tag information stored in the electronic price tag device according to the update instruction, wherein the update instruction comprises price tag information for updating, and the price tag information for updating comprises the first position information of the electronic price tag device.

4. The calling method of claim 1, wherein after the step of the server sending the calling information to the shopping guide terminal corresponding to the first position information, the calling method further comprises a step of:
the shopping guide terminal that receives the calling information sending out a prompt signal and displaying the first position information corresponding to the electronic price tag device, according to the calling information.

5. The calling method of claim 1, further comprising steps of:
the electronic price tag device determining whether the operation instruction of the user is received or not,
if the operation instruction of the user is received, the electronic price tag device performing the step of generating the request information according to the operation instruction of the user, and
if the operation instruction of the user is not received, the electronic price tag device continuing determining whether the operation instruction of the user is received or not.

6. An electronic price tag device, comprising a housing, a first processor and a first transceiver within the housing, and a call button on an outer surface of the housing,
wherein the call button is configured to generate an operation instruction when pressed by a user and to send the operation instruction to the first processor,
the first processor is configured to generate, according to the operation instruction of the user, request information comprising first position information of the electronic price tag device, and
the first transceiver is configured to send the request information to a server.

7. The electronic price tag device of claim 6, wherein the first transceiver is further configured to receive an update instruction sent from the server, the update instruction comprises price tag information for updating, and the price tag information for updating comprises the first position information of the electronic price tag device, and
the first processor is further configured to update price tag information stored in the electronic price tag device according to the update instruction.

8. A calling system, comprising a server, a plurality of shopping guide terminals and the electronic price tag device of claim 6,
wherein the electronic price tag device is configured to generate request information according to an operation instruction of a user and send the request information to the server, and the request information comprises first position information of the electronic price tag device, and
the server is configured to determine a shopping guide terminal corresponding to the first position information and send calling information to the shopping guide terminal corresponding to the first position information, and the calling information comprises the first position information.

9. The calling system of claim 8, wherein each of the plurality of shopping guide terminals is configured to send signal strength indication information and state information to the server, and
the server is further configured to receive the signal strength indication information and the state information sent from the plurality of shopping guide terminals, generate second position information of each of the plurality of shopping guide terminals according to the signal strength indication information, and determine, according to the first position information of the electronic price tag device and the second position information and the state information of each shopping guide terminal, the shopping guide terminal corresponding to the first position information from the plurality of shopping guide terminals.

10. The calling system of claim 8, wherein each of the plurality of shopping guide terminals comprises a second transceiver, a second processor and a prompter,
the second transceiver is configured to receive the calling information,
the second processor is configured to send a prompt signal to the prompter after the second transceiver receives the calling information, and
the prompter is configured to provide a prompt according to the prompt signal.

11. The calling system of claim 10, wherein each of the plurality of shopping guide terminals further comprises a display screen,
the second processor is further configured to, after the second transceiver receives the calling information, generate a display signal comprising the first position information, and send the display signal to the display screen, and
the display screen displays the display signal.

12. The calling system of claim 8, wherein the first transceiver of the electronic price tag device is further configured to receive an update instruction sent from the server, the update instruction comprises price tag information for updating, and the price tag information for updating comprises the first position information of the electronic price tag device, and
the first processor of the electronic price tag device is further configured to update price tag information stored in the electronic price tag device according to the update instruction.

13. The calling system of claim 8, comprising a plurality of electronic price tag devices.
